(19) United States
(12) Patent Application Publication
(10) Pub. No.: US 2008/0124554 A1
(43) Pub. Date: May 29, 2008

(54) SEMICONDUCTOR DEVICE AND METHOD FOR MANUFACTURING THE SAME

(76) Inventor: Ji-Ho HONG, Gyeonggi-do (KR)

Correspondence Address: SHERR & NOURSE, PLLC, 620 HERNDON PARKWAY, SUITE 200, HERNDON, VA, 20170, US

(21) Appl. No.: 11/932,013

(22) Filed: Oct. 31, 2007

(30) Foreign Application Priority Data
Nov. 27, 2006 (KR) 10-2006-0117458

(51) Int. Cl. B32B 27/06; B05D 5/12; B32B 27/30

(52) U.S. Cl. 428/419; 216/17; 427/255.6; 427/355; 428/500

(57) ABSTRACT

A semiconductor device includes a substrate and a first insulating layer, contact plugs, metal wirings, and a second insulating layer sequentially formed over the substrate. The first insulating layer has via holes. The contact plugs are formed in the via holes. The metal wirings are electrically connected to the contact plugs. The substrate and the first and second insulating layers include first, second, and third insulating macromolecular substances, respectively, with flexible and insulating properties. The contact plugs and metal wirings include first and second conducting macromolecular substances, respectively, with flexible and conductive properties. Using the flexible macromolecular substances to form the components of the semiconductor device makes it resistant to being easily broken by impacts and increases the possibility of application to products, since it may be applicable to locations where bending may be necessary.

The present application claims priority under 35 U.S.C. 119 to Korean Patent Application No. 10-2006-0117458, filed on Nov. 27, 2006, which is hereby incorporated by reference in its entirety.

### BACKGROUND

Semiconductor devices are widely used in the development of information technologies. Particularly, flexible semiconductor devices are increasingly needed in display and mobile devices. Flexible semiconductor devices can be curved so that they can be widely and effectively used when it is necessary to curve or bend the semiconductor devices when mounting or otherwise using them. Flexible semiconductor devices should be resistant to being broken by impacts and should tend to return to their original shapes.

However, in general, semiconductor devices are manufactured by forming metal-based wirings over a silicon-based substrate. These substrate and wirings may be broken relatively easily or may not return to their original shapes since they are formed of relatively inflexible substances.

### SUMMARY

Embodiments relate to a semiconductor device and a method for manufacturing the same, wherein flexible substances are used to form the semiconductor device, thereby preventing the semiconductor device from being easily broken when it is bent and also allowing it to return to its original shape.

Embodiments relate to a semiconductor device which includes a substrate having a plurality of device modules. The substrate includes a first insulating macromolecular substance having flexible and insulating properties. A first insulating layer may be formed over the substrate, the first insulating layer having a plurality of via holes and including a second insulating macromolecular substance having flexible and insulating properties. A plurality of contact plugs may be formed in the via holes, the contact plugs including a first conducting macromolecular substance having flexible and conductive properties. A plurality of metal wirings may be formed over the first insulating layer, the metal wirings being electrically connected to the contact plugs and including a second conducting macromolecular substance having flexible and conductive properties. A second insulating layer may be formed over the metal wirings, the second insulating layer including a third insulating macromolecular substance having flexible and insulating properties.

Embodiments relate to a method for manufacturing a semiconductor device which includes forming a substrate including a first insulating macromolecular substance having flexible and insulating properties. A first insulating layer may be formed over the substrate, the first insulating layer including a second insulating macromolecular substance having flexible and insulating properties. The first insulating layer may be patterned to form a plurality of via holes. A plurality of contact plugs may be formed in the via holes, the contact plugs including a first conducting macromolecular substance having flexible and conductive properties. A second conducting macromolecular substance having flexible and conductive properties may be deposited and patterned over the first insulating layer to form a plurality of metal wirings. A second insulating layer may be formed over the metal wirings, the second insulating layer including a third insulating macromolecular substance having flexible and insulating properties.

### DRAWINGS

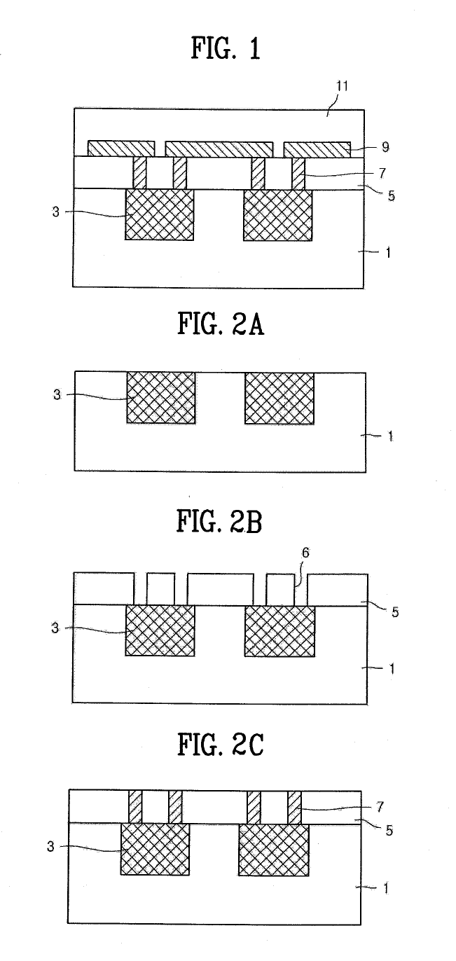

Example FIG. 1 schematically illustrates a semiconductor device according to embodiments.

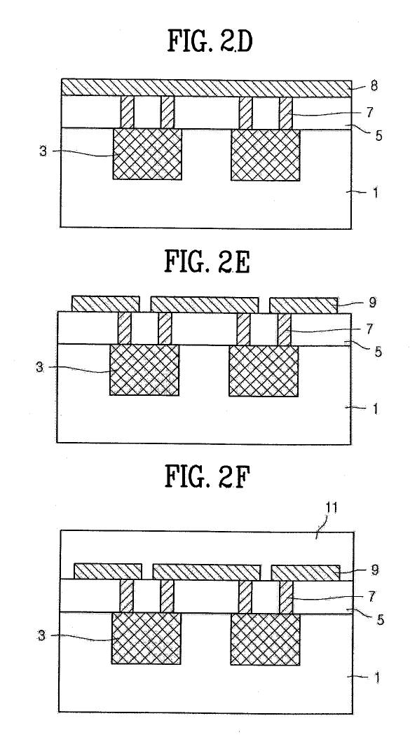

Example FIGS. 2A to 2F illustrate a method for manufacturing a semiconductor device according to embodiments.

### DESCRIPTION

Example FIG. 1 schematically illustrates a semiconductor device according to embodiments. As shown in example FIG. 1, a plurality of device modules 3 are formed over a substrate 1. The substrate 1 may include a first insulating macromolecular substance having flexible and insulating properties. The first insulating macromolecular substance may be polyimide. Although embodiments will be described using the polyimide as an example of the first insulating macromolecular substance, any other macromolecular substance having flexible and insulating properties may be used as the first insulating macromolecular substance. Polyimide is a substance having excellent insulating and flexible properties. Each of the device modules 3 may be a module having a specific function, for example a memory or a logic circuit. The memory or logic circuit may include a plurality of transistors, resistors, capacitors, or the like.

A pre-metal dielectric (PMD) layer 5 may be formed over the substrate 1 including the device modules 3. A plurality of contact plugs 7 electrically connected to the plurality of device modules 3 may be formed through the PMD layer 5. The PMD layer 5 may include a second insulating macromolecular substance having flexible and insulating properties. The second insulating macromolecular substance may be polyimide. Although embodiments will be described using the polyimide as an example of the second insulating macromolecular substance, any other macromolecular substance having flexible and insulating properties may be used as the second insulating macromolecular substance. Each of the contact plugs 7 may include a first conducting macromolecular substance having flexible and conductive properties. The first conducting macromolecular substance may be selected from the group consisting of polyacetylene, polyaniline, poly(p-phenylene), polypyrole, polythiophene, poly(p-phenylene vinylene), poly(3,4-ethylenedioxy thiophene), and poly(thienylene vinylene). Any other substance having flexible and conductive properties may be used as the first conducting macromolecular substance.

A plurality of metal wirings 9 electrically connected to the device modules 3 through the contact plugs 7 may be formed over the PMD layer 5 including the contact plug 7. The metal wirings 9 may include a second conducting macromolecular substance having flexible and conductive properties. The second conducting macromolecular substance may be selected from the group consisting of polyacetylene, polyaniline, poly(p-phenylene), polypyrole, polythiophene, poly(p-phenylene vinylene), poly(3,4-ethylenedioxy thiophene), and poly(thienylene vinylene). Any other substance having flexible and conductive properties may be used as the second conducting macromolecular substance.

An inter-metallic dielectric (IMD) layer 11 is formed over the metal wirings 9. The IMD layer 11 can protect the metal wirings 9. The metal wirings 9 may be exposed through the IMD layer 11 as needed. The exposed metal wirings 9 may be electrically connected to external devices to receive electrical signals from the external devices and to provide the electrical signals to the metal wirings 9. The IMD layer 11 may include a third insulating macromolecular substance having flexible and insulating properties. The third insulating macromolecular substance may be polyimide. Any other substance having flexible and insulating properties may be used as the third insulating macromolecular substance.

Since the substrate 1, the PMD layer 5, and the IMD layer 11 are each formed of a macromolecular substance having flexible and insulating properties and the contact plugs 7 and the metal wirings 9 are each formed of a macromolecular substance having flexible and conductive properties, the embodiments not only have the same functions as the conventional semiconductor device, but are also flexible. Accordingly, the embodiments not only can perform desired operations but also are not as easily broken by external impacts, thereby improving the product quality.

Example FIGS. 2A to 2F illustrate a method for manufacturing a semiconductor device according to embodiments.

First, as shown in example FIG. 2A, a substrate 1, including a first insulating macromolecular substance having flexible and insulating properties, is provided. The first insulating macromolecular substance may be polyimide. Any other macromolecular substance having flexible and insulating properties may be used as the first insulating macromolecular substance.

A plurality of device modules 3 having desired functions may be formed over the substrate 1. For example, each of the device modules 3 may be a memory or a logic circuit. The device modules 3 may be formed through related semiconductor manufacturing processes. Then, as shown in example FIG. 2B, a PMD layer 5 may be formed by depositing a second insulating macromolecular substance having flexible and insulating properties over the substrate 1 including the device modules 3. The second insulating macromolecular substance may be polyimide. Any other macromolecular substance having flexible and insulating properties may be used as the second insulating macromolecular substance.

The PMD layer 5 is patterned to form a plurality of via holes 6 exposing the device modules 3. The PMD layer 5 may be deposited through one of a spin coating process, a Chemical Vapor Deposition (CVD) process, and a copolymerization process.

When the spin coating process is employed, the PMD layer 5 is formed over the entire surface of the substrate 1 by depositing a second insulating macromolecular substance, which is a viscous liquid, over the substrate 1 and then rotating the substrate 1 to apply a centrifugal force to the deposited substance. The PMD layer 5 formed in this manner may be hardened through a hardening process.

When the copolymerization is employed, the a second insulating macromolecular substance may be formed over the substrate 1 by mixing a substance including monomers with an electrolyte and causing a polymerization reaction of the substance over the substrate 1 through a reduction reaction using electroplating chemical polishing (ECP).

The PMD layer 5 may be patterned using one of a dry etching process, a wet etching process, and an ashing process using oxygen (O₂). A plurality of via holes 6 may be formed through the patterning.

Then, as shown in example FIG. 2C, a plurality of contact plugs 7 are formed in the via holes 6. More specifically, first, a first conducting macromolecular substance is formed over the PMD layer 5. The first conducting macromolecular substance may be formed over the PMD layer 5 using one of a spin coating process, a CVD process, and a copolymerization process. When the Chemical Mechanical Polishing (CMP) process is employed, the CMP process is continued until the PMD layer 5 is exposed. This allows the contact plugs 7 to be formed only in the via holes 6 without being left over the PMD layer 5. The first conducting macromolecular substance may be selected from the group consisting of polyacetylene, polyaniline, poly(p-phenylene), polypyrole, polythiophene, poly(p-phenylene vinylene), poly(3,4-ethylenedioxy thiophene), and poly(thienylene vinylene). Any other substance having flexible and conductive properties may be used as the first conducting macromolecular substance.

Then, as shown in example FIG. 2D, a second conducting macromolecular substance 8 is deposited over the PMD layer 5 including the contact plugs 7 using one of a spin coating process, a CVD process, and a copolymerization process. The second conducting macromolecular substance 8 may be selected from the group consisting of polyacetylene, polyaniline, poly(p-phenylene), polypyrole, polythiophene, poly(p-phenylene vinylene), poly(3,4-ethylenedioxy thiophene), and poly(thienylene vinylene). Any other substance having flexible and conductive properties may be used as the second conducting macromolecular substance 8.

Then, as shown in example FIG. 2E, the second conducting macromolecular substance 8 is patterned to form a plurality of metal wirings 9 electrically connected to the contact plugs 7. The second conducting macromolecular substance 8 deposited over the PMD layer 5 may be patterned using one of a dry etching process, a wet etching process, and an ashing process using oxygen (O₂).

Then, as shown in example FIG. 2F, a third insulating macromolecular substance is deposited over the metal wirings 9 to form an IMD layer 11. The third insulating macromolecular substance may be deposited over the metal wirings 9 using one of a spin coating process, a CVD process, and a copolymerization process. The IMD layer 11 may include a third insulating macromolecular substance having flexible and insulating properties. The third insulating macromolecular substance may be polyimide. Any other substance having flexible and insulating properties may be used as the third insulating macromolecular substance.

The above description has been given with reference to a subtractive method in which metal wirings are formed through a patterning process. The subtractive method has been widely used when metal wirings are formed by patterning a substance such as aluminum (Al) which is easy to pattern.

However, embodiments can also be applied to a damascene method in the same manner. The damascene method has been widely used when metal wirings are formed using a Chemical Mechanical Polishing (CMP) process after trenches are filled with a substance such as Cu which is not easy to pattern.

Any of the subtractive or damascene methods can be easily used to form metal wirings of the semiconductor device of embodiments.

As is apparent from the above description, embodiments provide a semiconductor device and a method for manufacturing the same with a variety of features and advantages. For example, a substrate, insulating layers, contact plugs, and metal wirings which constitute the semiconductor device are each formed of a flexible macromolecular substance, which prevents the semiconductor device from being easily broken by external impacts and increases the possibility of application to products, since the semiconductor device can be applied to locations where it may be necessary to bend it, and thus improves the quality of products.

It will be obvious and apparent to those skilled in the art that various modifications and variations can be made in the embodiments disclosed. Thus, it is intended that the disclosed embodiments cover the obvious and apparent modifications and variations, provided that they are within the scope of the appended claims and their equivalents.

What is claimed is:

1. An apparatus comprising:
a substrate having a plurality of device modules, the substrate including a first insulating macromolecular substance having flexible and insulating properties;
a first insulating layer formed over the substrate, the first insulating layer having a plurality of via holes and including a second insulating macromolecular substance having flexible and insulating properties;
a plurality of contact plugs formed in the via holes, the contact plugs including a first conducting macromolecular substance having flexible and conductive properties;
a plurality of metal wirings formed over the first insulating layer, the metal wirings being electrically connected to the contact plugs and including a second conducting macromolecular substance having flexible and conductive properties; and
a second insulating layer formed over the metal wirings, the second insulating layer including a third insulating macromolecular substance having flexible and insulating properties.

2. The apparatus of claim 1, wherein each of the first to third insulating macromolecular substances is polyimide.

3. The apparatus of claim 1, wherein each of the first and second conducting macromolecular substances is selected from the group consisting of polyacetylene, polyaniline, poly(p-phenylene), polypyrole, polythiophene, poly(p-phenylene vinylene), poly(3,4-ethylenedioxy thiophene), and poly(thienylene vinylene).

4. The apparatus of claim 1, wherein the first insulating layer formed over the substrate is a pre-metal dielectric layer.

5. The apparatus of claim 1, wherein the a second insulating layer formed over the metal wirings is an inter-metallic dielectric layer.

6. A method comprising:
forming a substrate including a first insulating macromolecular substance having flexible and insulating properties;
forming a first insulating layer over the substrate, the first insulating layer including a second insulating macromolecular substance having flexible and insulating properties;
patterning the first insulating layer to form a plurality of via holes;
forming a plurality of contact plugs in the via holes, the contact plugs including a first conducting macromolecular substance having flexible and conductive properties;
depositing and patterning a second conducting macromolecular substance having flexible and conductive properties over the first insulating layer to form a plurality of metal wirings; and
forming a second insulating layer over the metal wirings, the second insulating layer including a third insulating macromolecular substance having flexible and insulating properties.

7. The method of claim 6, wherein each of the first to third insulating macromolecular substances is polyimide.

8. The method of claim 6, wherein each of the first and second conducting macromolecular substances is polyacetylene.

9. The method of claim 6, wherein each of the first and second conducting macromolecular substances is polyaniline.

10. The method of claim 6, wherein each of the first and second conducting macromolecular substances is poly(p-phenylene).

11. The method of claim 6, wherein each of the first and second conducting macromolecular substances is polypyrole.

12. The method of claim 6, wherein each of the first and second conducting macromolecular substances is polythiophene.

13. The method of claim 6, wherein each of the first and second conducting macromolecular substances is poly(p-phenylene vinylene).

14. The method of claim 6, wherein each of the first and second conducting macromolecular substances is poly(3,4-ethylenedioxy thiophene).

15. The method of claim 6, wherein each of the first and second conducting macromolecular substances is poly(thienylene vinylene).

16. The method of claim 6, wherein the first and second insulating layers and the metal wirings are deposited using a spin coating process.

17. The method of claim 6, wherein the first and second insulating layers and the metal wirings are deposited using a CVD process.

18. The method of claim 6, wherein the first and second insulating layers and the metal wirings are deposited using a copolymerization process.

19. The method of claim 6, wherein the first insulating layer and the metal wirings are patterned using one of a dry etching process, a wet etching process, and an ashing process using oxygen.

20. The method of claim 6, wherein the metal wirings are formed using one of a subtractive method and a damascene method.
